(19) United States
(12) Patent Application Publication
(10) Pub. No.: US 2022/0167083 A1
(43) Pub. Date: May 26, 2022

(54) SIGNAL PROCESSING APPARATUS, SIGNAL PROCESSING METHOD, PROGRAM, AND DIRECTIVITY VARIABLE SYSTEM

(71) Applicant: SONY GROUP CORPORATION, TOKYO (JP)

(72) Inventor: TATSUYA KOIZUMI, TOKYO (JP)

(21) Appl. No.: 17/602,883

(22) PCT Filed: Mar. 9, 2020
(86) PCT No.: PCT/JP2020/010089

§ 371 Date: Oct. 11, 2021

(30) Foreign Application Priority Data
Apr. 19, 2019 (JP) 2019-080258

(51) Int. Cl. H04R 1/40; H04R 5/027

(52) U.S. Cl. CPC H04R 1/406; H04R 5/027

(57) ABSTRACT

Provided is a signal processing apparatus including a directivity processing unit which acquires sound signals of a plurality of channels, the sound signals being concurrently picked up by a microphone array being constituted of a plurality of microphones, the directivity processing unit generating sound signals for varying directivity by using the acquired sound signals of the plurality of channels, a number of the sound signals for varying the directivity being smaller than a number of the channels, directional characteristics of the sound signals for varying the directivity being different from each other.

### TECHNICAL FIELD

The present technology relates to a signal processing apparatus, a signal processing method, a program, and a directivity variable system.

### BACKGROUND ART

There have been known technologies, in each of which after recording sound, directivity of the sound can be varied. For example, there have been known a technology in which sounds are concurrently recorded by two microphones whose directivity characteristics are different from each other and the sounds are added, thereby changing the directivity and a technology in which a microphone array is used and beam forming (for example, the below-mentioned Patent Document 1) is used, thereby changing the directivity.

### CITATION LIST

### Patent Document

Patent Document 1: Japanese Patent Application Laid-Open No. 2017-107141

### SUMMARY OF THE INVENTION

### Problems to be Solved by the Invention

However, the former of the above-mentioned technologies has not been capable of realizing varying of the directivity at high accuracy. On the other hand, in the latter of the above-mentioned technologies, when in order to enhance accuracy at which the directivity is varied, a number of microphones is increased, a number of sound channels is increased, thereby leading to a problem in that a system becomes complicated.

Accordingly, one of objects of the present technology is to provide a signal processing apparatus, a signal processing method, a program, and a directivity variable system, each of which can realize varying of the directivity at high accuracy without complicating a system.

### Solutions to Problems

The present technology is

a signal processing apparatus including

a directivity processing unit which acquires sound signals of a plurality of channels, the sound signals being concurrently picked up by a microphone array being constituted of a plurality of microphones, the directivity processing unit generating sound signals for varying directivity by using the acquired sound signals of the plurality of channels, a number of the sound signals for varying the directivity being smaller than a number of the channels, directional characteristics of the sound signals for varying the directivity being different from each other.

The present technology is

a signal processing apparatus which includes:

an input unit to which sound signals for varying directivity are inputted, the sound signals being generated by using sound signals of a plurality of channels, the sound signals of the plurality of channels being concurrently picked up by a microphone array being constituted of a plurality of microphones, a number of the sound signals for varying the directivity being smaller than a number of the channels, directional characteristics of the sound signals for varying the directivity being different from each other; and

a directivity variable unit which synthesizes the sound signals for varying the directivity being inputted to the input unit at a predetermined ratio and generates a sound signal having directivity in accordance with the ratio.

The present technology is

a signal processing method in which

a directivity processing unit acquires sound signals of a plurality of channels, the sound signals of the plurality of channels being concurrently picked up by a microphone array being constituted of a plurality of microphones, and generates sound signals for varying directivity by using the acquired sound signals of the plurality of channels, a number of the sound signals for varying the directivity being smaller than a number of the channels, directional characteristics of the sound signals for varying the directivity being different from each other.

The present technology is

a program which causes a computer to execute a signal processing method in which

a directivity processing unit acquires sound signals of a plurality of channels, the sound signals of the plurality of channels being concurrently picked up by a microphone array being constituted of a plurality of microphones, and generates sound signals for varying directivity by using the acquired sound signals of the plurality of channels, a number of the sound signals for varying the directivity being smaller than a number of the channels, directional characteristics of the sound signals for varying the directivity being different from each other.

The present technology is

a directivity variable system which includes:

a directivity processing unit which acquires sound signals of a plurality of channels, the sound signals being concurrently picked up by a microphone array being constituted of a plurality of microphones, the directivity processing unit generating sound signals for varying directivity by using the acquired sound signals of the plurality of channels, a number of the sound signals for varying the directivity being smaller than a number of the channels, directional characteristics of the sound signals for varying the directivity being different from each other;

a recording unit which records, in a recording medium, the sound signals for varying the directivity being generated by the directivity processing unit;

a directivity variable unit which acquires the sound signals for varying the directivity being read out from the recording medium, synthesizes the acquired sound signals for varying the directivity at a predetermined ratio, and generates a sound signal having directivity in accordance with the ratio; and

a reproducing unit which reproduces the sound signal being generated by the directivity variable unit.

### BRIEF DESCRIPTION OF DRAWINGS

FIG. 1 is a block diagram illustrating a configuration example of a directivity variable system to which the present technology can be applied.

FIG. 2 is a functional block diagram illustrating a configuration example of the directivity variable system on a recording side.

FIG. 3 is a diagram illustrating a polar pattern showing a specific example of a first directional characteristic.

FIG. 4 is a diagram illustrating a polar pattern showing a specific example of a second directional characteristic.

FIG. 5 is a functional block diagram illustrating a configuration example of the directivity variable system on a reproducing side.

FIG. 6 is a graph for explaining one example of synthesis of sound signals.

FIG. 7 is a diagram illustrating each polar pattern showing a specific example of sound signals after the synthesis.

FIG. 8 is an explanatory diagram for explaining a specific example in which characteristics are not matched.

FIG. 9 is a diagram illustrating polar patterns showing a specific example of first and second directional characteristics.

FIG. 10 is a diagram illustrating polar patterns showing a specific example of sound signals after the synthesis.

FIG. 11 is a diagram schematically illustrating an overall configuration of an operation room system.

FIG. 12 is a diagram illustrating a display example of an operation screen of a central operation panel.

FIG. 13 is a diagram illustrating one example of a view of an operation in which the operation room system is applied.

FIG. 14 is a block diagram illustrating one example of a function configuration of each of a camera head and a CCU illustrated in FIG. 13.

### MODE FOR CARRYING OUT THE INVENTION

Hereinafter, an embodiment of the present technology will be described with reference to the accompanying drawings. Note that the below-described embodiment is a preferred specific example of the present technology, and although a variety of preferred technical limitations are added thereto, the scope of the present technology shall not be limited to these embodiments unless otherwise described as limiting the present technology in the following. The present technology will be described in the following order.

<1. One Embodiment>

<2. Modified Example>

<3. Application Example>

### 1. One Embodiment

[1-1. Overall Configuration of Directivity Variable System]

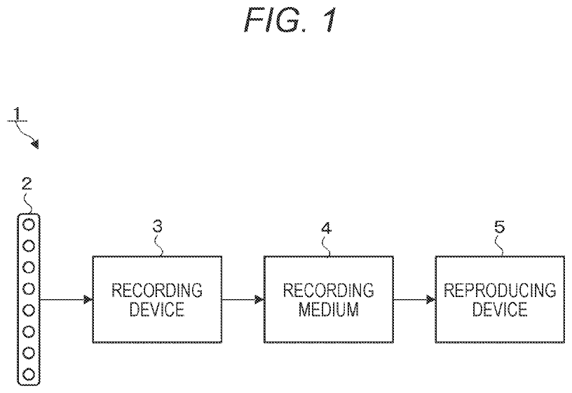

FIG. 1 is a block diagram illustrating a configuration example of a directivity variable system to which the present technology can be applied. A directivity variable system 1 illustrated in FIG. 1 is a system which makes directional characteristics (for example, a direction in which sound after being recorded is emphasized) variable for the sound. For example, after finishing recording in interview material gathering outdoors or the like, when the recorded sound is checked, there may be a case where it is desired that the surrounding hustle and bustle is taken therein or that the surrounding hustle and bustle is removed and the talk of a speaker is emphasized, or other case. This directivity variable system 1 is, for example, in such a case, to allow directional characteristics as to the sound after being recorded to be varied.

As illustrated, the directivity variable system 1 has a microphone array 2, a recording device 3, a recording medium 4, and a reproducing device 5. The microphone array 2 is operable to output sound signals of a plurality of channels, which are concurrently picked up. The microphone array 2 is connected to the recording device 3, and the sound signals of the plurality of channels, which are outputted from the microphone array 2, are inputted to the recording device 3.

The recording device 3 is, for example, a device, such as a sound recording device, an editing device, or a video camera, which is operable to record the sound signals. This recording device 3 subjects the sound signals of the plurality of channels, inputted from the microphone array 2, to the later-described signal processing, generates sound signals for varying directivity, and records the generated sound signals for varying the directivity in the recording medium 4 which can be connected to the recording device 3.

A kind of the recording medium 4 is not particularly limited, and for example, an optical disc such as a Blu-ray Disc (registered trademark) (BD), a hard disc, and a flash memory such as an SD card and a solid state drive (SSD) can be adopted. The recording medium 4 may be built in the recording device 3 or may be detachable. The recording medium 4 is configured to be connectable to the reproducing device 5 and outputs recorded sound data for varying the directivity to the reproducing device 5 under control of the reproducing device 5.

Upon reproducing the sound signals, the reproducing device 5 subjects the sound signals for varying the directivity, inputted from the recording medium 4, to the later-described signal processing, generates sound signals whose directional characteristics are appropriately changed, specifically, whose emphasis direction of sound with the microphone array 2 as a point of origin upon picking up the sound, and outputs sound based on the generated sound signals from an output device (not illustrated) such as a loudspeaker.

Note that although the microphone array 2, the recording device 3, the recording medium 4, and the reproducing device 5 of which this directivity variable system 1 is constituted may be separate components as illustrated in FIG. 1, all or a part of the microphone array 2, the recording device 3, the recording medium 4, and the reproducing device 5 may be integrally configured in accordance with applications or the like. Also as to the above-mentioned output device, the similar is applied. In addition, an interface for connection of the above-mentioned components is not limited to a specific interface. For example, the interface is not limited to wired connection and may be wireless connection utilizing Bluetooth (registered trademark), Wi-Fi (registered trademark), or the like. In addition, the interface is not limited to an interface utilizing peer-to-peer (P2P) connection and may be an interface utilizing a local area network (LAN), an Internet network, a mobile telephone communication network, or the like.

[1-2. Signal Processing on Recording Side]

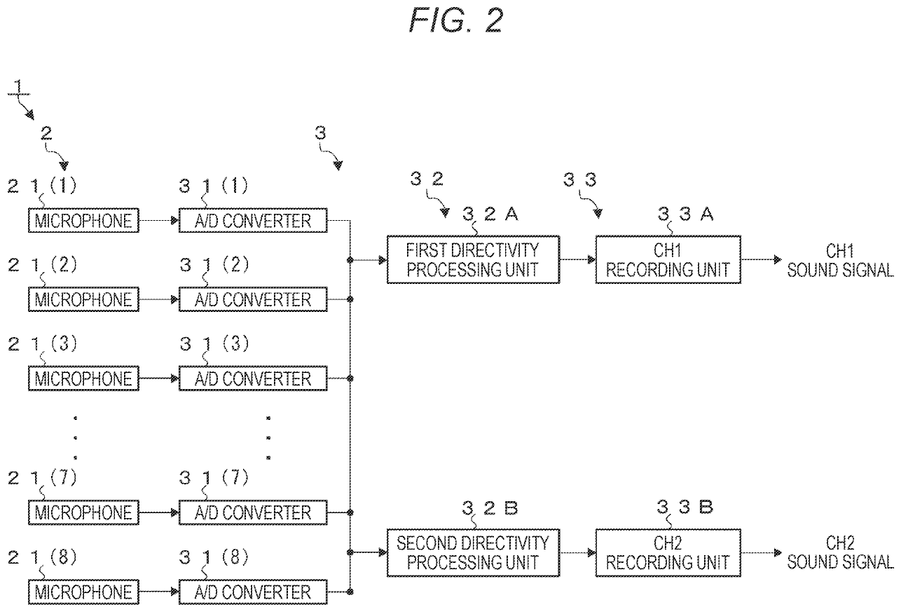

FIG. 2 is a functional block diagram illustrating a configuration example of the directivity variable system 1 on a recording side. The above-described microphone array 2 has eight microphones 21 (1) to (8) which are arranged in an array form. For example, it is only required for an arrangement pattern of the microphones 21 (1) to (8) to be suited for the later-described signal processing, and the arrangement pattern is not limited to a linear pattern illustrated in FIG. 1 and may be other arrangement pattern such as a ring shape, a lattice shape, or any shape. Note that although in the present embodiment, a case where a number of the microphones 21 is eight is illustrated, the number of the microphones 21 is not limited thereto and can be appropriately set. In accordance with an increase in the number of the microphones 21, varying of the directional characteristics at high accuracy can be realized.

Each of the microphones 21 (1) to (8) has, specifically, a configuration in which sound (aerial vibration) received by a vibration unit such as a diaphragm is converted to an analog sound signal and the analog sound signal is outputted. For example, all of these microphones 21 (1) to (8) are the same as one another and have the same characteristics (directional characteristics, frequency characteristics, noise characteristics, and the like) (for example, all of the directional characteristics are non-directivities). The microphone array 2 is configured to be operable to output sound signals of eight channels, which are concurrently picked up with the same characteristics, by using these eight microphones 21 (1) to (8).

On the other hand, the above-described recording device 3 has eight A/D converters 31 (1) to (8), a directivity processing unit 32, and a recording unit 33. Note that the directivity processing unit 32 has a first directivity processing unit 32A and a second directivity processing unit 32B and the recording unit 33 has a CH1 recording unit 33A and a CH2 recording unit 33B.

The A/D converters 31 (1) to (8) are connected to the above-described microphones 21 (1) to (8), respectively and the sound signals outputted by the microphones 21 (1) to (8) are inputted to the A/D converters 31 (1) to (8), respectively. The A/D converters 31 (1) to (8) convert the inputted sound signals to digital signals. In addition, the A/D converters 31 (1) to (8) are connected to the first directivity processing unit 32A and the second directivity processing unit 32B, respectively.

For example, the directivity processing unit 32 is constituted of a digital signal processor (DSP), a central processing unit (CPU), or the like. This directivity processing unit 32 acquires the sound signals of the eight channels, outputted from the above-described microphone array 2, generates two sound signals, whose number is smaller than the number of the channels and whose directional characteristics are different from each other, by using the acquired sound signals of the eight channels, and outputs the sound signals for varying directivity. Specifically, by using the sound signals inputted from the respective A/D converters 31 (1) to (8), the first directivity processing unit 32A generates and outputs a first sound signal (CH1 sound signal) for varying directivity, which has a first directional characteristic, and the second directivity processing unit 32B generates and outputs a second sound signal (CH2 sound signal) for varying directivity, which has a second directional characteristic different from the first directional characteristic. In other words, the directivity processing unit 32 generates and outputs the sound signals of two channels, for varying the directivity.

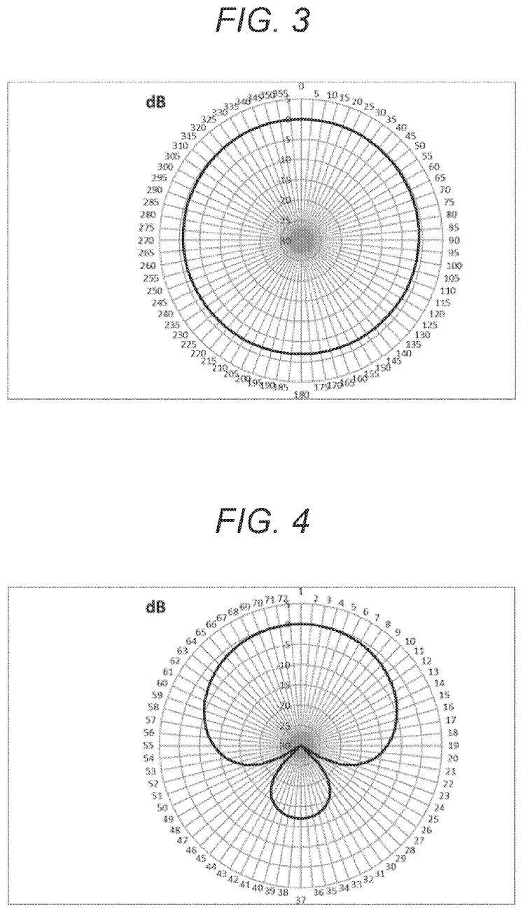

In the present embodiment, an example in which as one example of the directional characteristic, a pattern of directivity (sharpness of directivity) is cited is described. FIG. 3 is a diagram illustrating a polar pattern showing a specific example of a first directional characteristic, and FIG. 4 is a diagram illustrating a polar pattern showing a specific example of a second directional characteristic. As shown in FIG. 3, the first directivity processing unit 32A generates a sound signal whose directional characteristic is non-directivity (an omnidirectional characteristic), that is, a sound signal whose sensitivities are the same as one another in all directions at 360 degrees as the CH1 sound signal. In addition, the second directivity processing unit 32B generates, as the CH2 sound signal, a sound signal which forms a Super-Cardioid-shaped curve mainly emphasizing a sound in a front direction as a directional characteristic.

Specifically, by using the sound signals of the eight channels, outputted from the A/D converters 31 (1) to (8), and employing the already-known beam forming technology or the like, the first directivity processing unit 32A and the second directivity processing unit 32B generate the CH1 sound signal and the CH2 sound signal. Although the detailed description is omitted here, the beam forming is a technology in which directivity is changed (sound in a specific direction is emphasized) by calculating delays in sound arrival times to the microphones at designated angles and making correction (for example, adjustment of amplitudes and phases). Note that as long as the sound in the specific direction can be emphasized by using the inputted sound signals, a technology other than the beam forming may be applied. In addition, a technology for the first directivity processing unit 32A and a technology for the second directivity processing unit 32B which are different from each other may be adopted.

As illustrated in FIG. 2, the directivity processing unit 32 is connected to the recording unit 33, and the sound signals of the two channels, which are generated by the directivity processing unit 32 and whose directional characteristics are different from each other, are outputted to the recording units 33, respectively. Specifically, the CH1 sound signal generated by the first directivity processing unit 32A is outputted to the CH1 recording unit 33A, and the CH2 sound signal generated by the second directivity processing unit 32B is outputted to the CH2 recording unit 33B.

The recording unit 33 records the two sound signals for varying the directivity, which are inputted from the directivity processing unit 32 and whose directional characteristics are different from each other, in the recording medium 4 illustrated in FIG. 1 (not illustrated in FIG. 2). Specifically, the CH1 recording unit 33A records the CH1 sound signal in the recording medium 4 and the CH2 recording unit 33B records the CH2 sound signal in the recording medium 4. Thus, the sound signals of the two channels are recorded in the recording medium 4. In other words, the sound signal having the directional characteristic of the non-directivity is recorded as the CH1 sound signal, and the sound signal having the directional characteristic which forms the Super-Cardioid-shaped curve is recorded as the CH2 sound signal.

[1-3. Signal Processing on Reproducing Side]

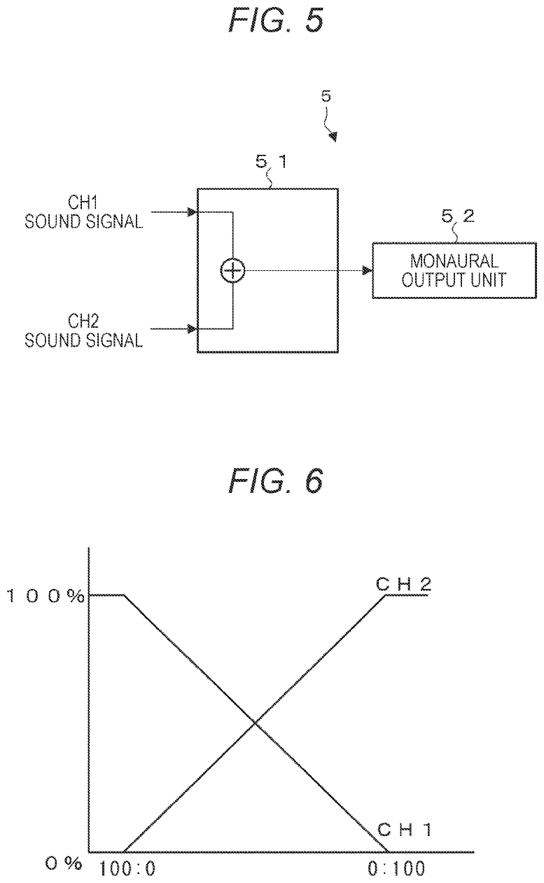

FIG. 5 is a functional block diagram illustrating a configuration example of the directivity variable system 1 on a reproducing side. As illustrated therein, the reproducing device 5 has a directivity variable unit 51 and a monaural output unit 52 as a reproducing unit. The recording medium 4 illustrated in FIG. 1 outputs the two sound signals for varying the directivity, which are recorded by the above-described recording unit 33 and whose directional characteristics are different from each other, to the directivity variable unit 51 under control by the reproducing device 5 (for example, a reproduction instruction). In other words, the CH1 sound signal and the CH2 sound signal are outputted.

For example, the directivity variable unit 51 is constituted of a signal processing apparatus such as a digital signal processor (DSP) and a central processing unit (CPU). In a case where the reproducing device 5 is configured to be integral with the above-described recording device 3, this signal processing apparatus may be in common with a signal processing apparatus of the recording device 3. This directivity variable unit 51 adds the two sound signals (the CH1 sound signal and the CH2 sound signal) for varying the directivity, which are inputted to an input unit (not illustrated) such as a predetermined interface from the recording medium 4 and whose directional characteristics are different from each other, at a predetermined ratio, that is, synthesizes the two sound signals, and generates and outputs a sound signal having directivity in accordance with the above-mentioned ratio.

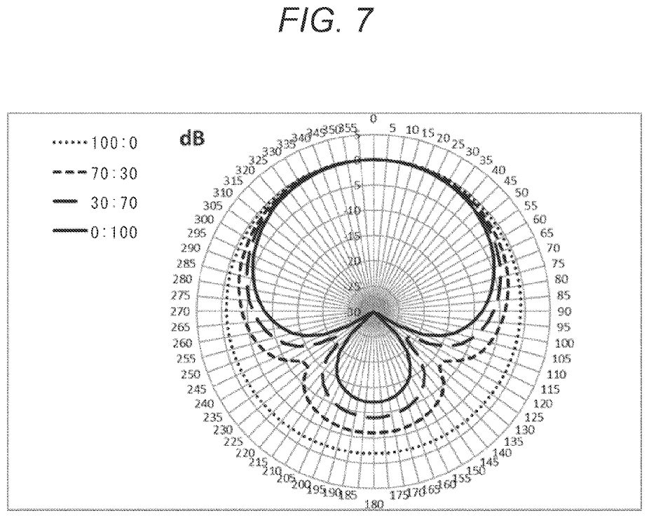

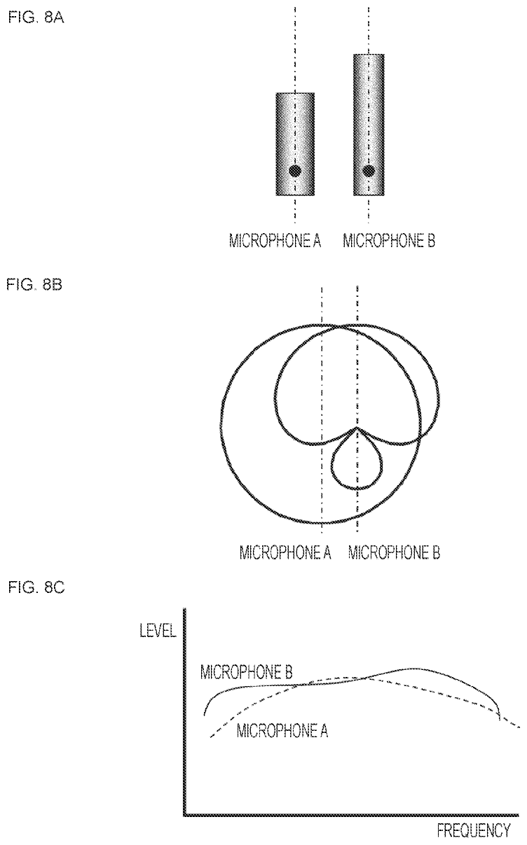

FIG. 6 is a graph for explaining one example of synthesis of the sound signals. Specifically, as shown in FIG. 6, the directivity variable unit 51 is configured to be capable of setting the ratio in a range of 0% to 100% such that a sum of a percentage of the CH1 sound signal and a percentage of the CH2 sound signal is 100%. For example, a user issues an instruction (makes selection or performs input) by using an input apparatus (not illustrated), thereby setting this ratio. This setting may be previously made or may be setting which can be changed in real time during reproduction. The setting can be changed in real time, thereby allowing sound which should be emphasized to be switched. Note that the setting may be automatically made in accordance with predetermined setting such as setting in which voice of a speaker is most emphasized.

FIG. 7 is a diagram illustrating each polar pattern showing a specific example of sound signals after the synthesis. As shown therein, for example, in a case where the CH1 sound signal and the CH2 sound signal are mixed by the directivity variable unit 51 in setting in which the percentage of the CH1 sound signal is 100% and the percentage of the CH2 sound signal is 0%, a sound signal having a directional characteristic of non-directivity, indicated by a broken line constituted of the finest dots, is generated. On the other hand, in a case where the CH1 sound signal and the CH2 sound signal are mixed in setting in which the percentage of the CH1 sound signal is 0% and the percentage of the CH2 sound signal is 100%, a sound signal having a directional characteristic which forms a Super-Cardioid-shaped curve, indicated by a solid line, is generated. Then, by appropriately changing the setting of the ratio, a sound signal having a desired directional characteristic between these both of the directional characteristics is generated.

As illustrated in FIG. 5, the directivity variable unit 51 is connected to the monaural output unit 52, and this generated sound signal is outputted to the monaural output unit 52. The monaural output unit 52 controls an output device (not illustrated) such as a loudspeaker to output, from the output device, sound based on the sound signal inputted from this directivity variable unit 51. As described above, since in the directivity variable system 1, the directional characteristic is changed by using the CH1 sound signal and the CH2 sound signal whose characteristics are uniform, varying of the directional characteristics at high accuracy can be realized.

FIG. 8 is an explanatory diagram for explaining a specific example in which characteristics are not matched. For example, in a case where two microphones (a microphone A and a microphone B) whose directivities are physically different are arranged, as illustrated in FIG. 8A, with respect to a center position of the microphone (for example, the microphone A) serving as reference, a center position of the other microphone (for example, the microphone B) is deviated. When the microphones whose configurations are physically different are used as described above, in a case where concurrent recording is performed, the microphones cannot be arranged in the exactly same positions and as illustrated in FIG. 8B, discrepancy in directional characteristics is caused. Therefore, sound signals concurrently outputted from the microphone A and the microphone B are synthesized by changing the ratio in the addition processing as described above and a sound signal having predetermined directivity is thereby generated, thereby leading to a result that accuracy of the generated sound signal is lowered. In addition, in a case where the two microphones (the microphone A and the microphone B) whose directivities are physically different are arranged, it is difficult to make also characteristics other than the directional characteristics exactly uniform. For example, as illustrated in FIG. 8C, discrepancy also in frequency characteristics is caused. Furthermore, noise levels of the microphones are different from each other. These differences incur further reduction in accuracy.

In contrast to this, in the directivity variable system 1 in the present embodiment, the microphone array 2 is constituted of a microphone array having the eight microphones 21 (1) to (8) whose characteristics such as the directional characteristics, the frequency characteristics, and the noise characteristics are the same, and the CH1 sound signal and the CH2 sound signal whose directional characteristics are different from each other are generated by using the sound signals outputted from the microphone array 2 and performing the signal processing such as the beam forming. Accordingly, the discrepancy in the above-described characteristics is eliminated and the directivity can be changed at high accuracy with the uniform characteristics.

In addition, in this directivity variable system 1, upon recording, the sound signals of the two channels for varying the directivity are generated from the sound signals of the eight channels and are recorded in the recording medium 4. Then, upon reproducing, by using these sound signals of the two channels, the directional characteristic is changed. In other words, since by using the sound signals of the two channels, the directional characteristic can be changed after recording the sound signals, varying of the directional characteristic can be realized without complicating the system.

### 2. Modified Example

Hereinbefore, the embodiment of the present technology is specifically described. However, contents of the present technology are not limited to the above-described embodiment, and a variety of modifications can be made. For example, generation of the sound signals in the above-described first directivity processing unit 32A and second directivity processing unit 32B are not limited to generation of those having the above-described directional characteristics shown in FIG. 3 and FIG. 4. Specifically, it is only required to appropriately select two directivity patterns, which are different from each other, from non-directivity, uni-directivity, bi-directivity, narrow directivity, sharp directivity, super-directivity, and the like. These directional characteristics may be previously set or may be selectable by a user via an input apparatus (not illustrated) or the like. In addition, the characteristics themselves may be characteristics which can be freely set by a user. In addition, the directivity patterns of the CH1 sound signal and the CH2 sound signal may be the same as each other.

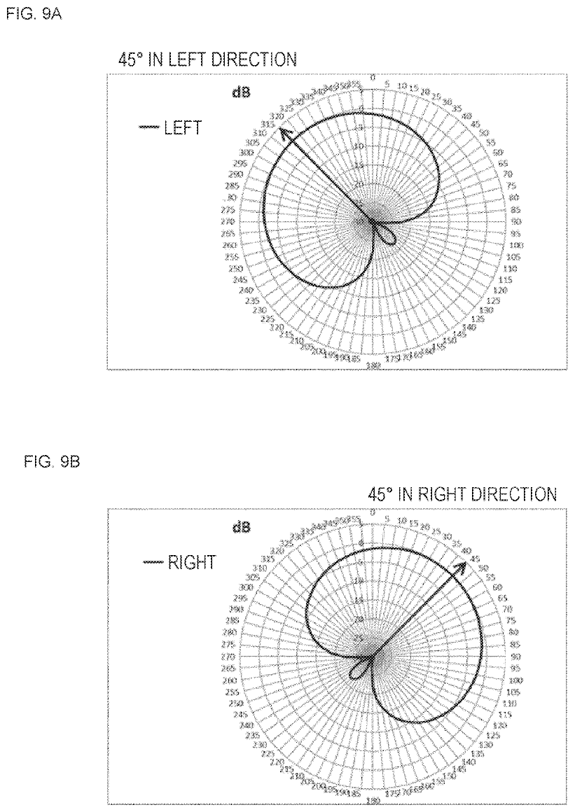

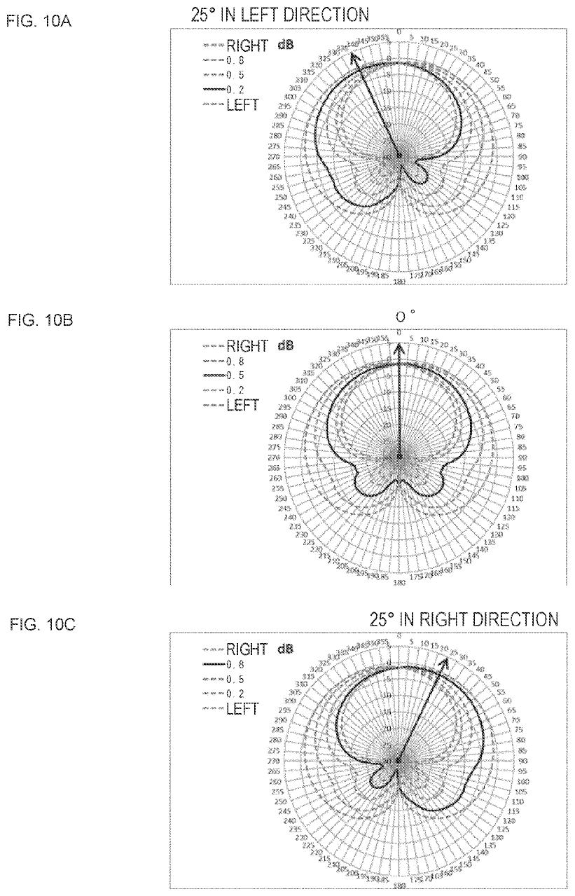

In addition, although in the above-described one embodiment, description is given by citing as an example the directivity pattern as the directional characteristic, the directional characteristic may be a directivity angle (a direction of a directional main axis) or may be both of the directivity pattern and the directivity angle. FIG. 9 is a diagram illustrating polar patterns showing a specific example of first and second directional characteristics. FIG. 9A is a diagram showing a first directional characteristic and FIG. 9B is a diagram showing a second directional characteristic.

As shown therein, a sound signal having a directional characteristic whose directivity angle is 45° in a left direction may be generated as the CH1 sound signal by the first directivity processing unit 32A, and a sound signal having a directional characteristic whose directivity angle is 45° in a right direction may be generated as the CH2 sound signal by the second directivity processing unit 32B. In a case of this example, the CH1 sound signal and the CH2 sound signal are added, that is, are subjected to a mixing operation by the above-described directivity variable unit 51 of the reproducing device 5, thereby allowing the directivity angle to be changed in a range of 45° in the left direction to 45° in the right direction.

FIG. 10 is a diagram illustrating polar patterns showing a specific example of sound signals after the synthesis. As shown therein, for example, in a case where the ratio of the CH1 sound signal and the CH2 sound signal is set to 8:2, as shown in FIG. 10A, a sound signal having a directional characteristic whose directivity angle is 25° in the left direction can be generated. In addition, in a case where this ratio is set to 5:5, as shown in FIG. 10B, a sound signal having a directional characteristic whose directivity angle is 0° , that is, facing a front direction can be generated, and in a case where the ratio is set to 2:8, as shown in FIG. 10C, a sound signal having a directional characteristic whose directivity angle is 25° in the right direction can be generated. In other words, the directivity angle is changed, thereby allowing sound to be appropriately emphasized in the right or left direction.

Furthermore, for example, although in the above-described one embodiment, the case where monaural output is performed is illustrated, an application to stereo output can also be made. For example, in such a case, a first sound signal and a second sound signal (two sound signals on an L side) having directional characteristics which are different from each other and whose each left direction is emphasized (having directivity angles in the left direction) are generated by the above-described first directivity processing unit 32A, a third sound signal and a fourth sound signal (two sound signals on an R side) having directional characteristics which are different from each other and whose each right direction is emphasized (having directivity angles in the right direction) are generated by the above-described second directivity processing unit 32B, and the first, second, third, and fourth sound signals are recorded in the above-described recording medium 4. In other words, the sound signals of four channels (CH1 to CH4) are recorded in the recording medium 4. Then, in the reproducing device 5, the CH1 sound signal and the CH2 sound signal are subjected to the mixing operation and the CH3 sound signal and the CH4 sound signal are subjected to the mixing operation, thereby generating the sound signals on the right and left (LR) sides. Thus, the directivity of stereo sound can be changed on the right and left sides.

In addition, for example, although in the above-described one embodiment, as the recording device 3 which records the sound signals in the recording medium 4, the signal processing apparatus for generating the sound signals for varying the directivity is applied, the present technology is not limited thereto and can be applied to a transmission apparatus which not only records but also transmits sound signals, such as a microphone control unit for wireless microphones. In addition, the present technology can be applied to a recording device which records the sound transmitted from the transmission apparatus and a reproducing device which reproduces the sound. As described above, the present technology is applied to a system whose number of channels is limited, thereby allowing effect similar to that attained by the above-described one embodiment to be exhibited.

Furthermore, for example, although in the above-described one embodiment, the configuration in which the two CH1 sound signal and CH2 sound signal as the sound data for varying the directivity are generated is illustrated, it is only required for the configuration to generate sound signals whose number is smaller than the number of channels of the microphone array 2. For example, the configuration may be a configuration in which three sound signals CH1 to CH3 are generated by the directivity processing unit 32, and the sound signals CH1 to CH3 are added at a predetermined ratio by the directivity variable unit 51, thereby changing the directivity.

A part of the processing in the above-described directivity variable system 1 may be performed by an apparatus on a cloud. In addition, although in the above-described one embodiment, as a preferred example, the example in which the sound signals for varying the directivity are once recorded and thereafter, are reproduced is described, the sound signals may be reproduced in real time without recording the sound signals. In addition, the sound signals for varying the directivity may be outputted to an external apparatus. In addition, the sound signals for varying the directivity may be supplied via a network such as the Internet, instead of the recording medium. In addition, the signal processing apparatus may have the microphone array 2. The microphone array 2 may be, for example, attachable to and detachable from an imaging device.

The signal processing apparatus according to the present technology can be configured in various aspects.

For example, the signal processing apparatus can be configured as a signal processing apparatus having the directivity processing unit 32.

In addition, the signal processing apparatus may be a signal processing apparatus having the directivity processing unit 32 and the directivity variable unit 51.

In addition, the above-described signal processing apparatus may be configured to have a function of at least one of the recording device 3 or the reproducing device 5.

Note that the directional main axis is, for example, an axis which extends from a center of the polar pattern to a position where the directivity is sharpest. In FIG. 7, angles of the directional main axis are the same, and in FIG. 9, angles of the directional main axis are different from one another, and the directivity patterns and angles of the directional main axis with respect to the patterns are determined depending on a case where only sound required for one sound source or a plurality of sound sources is desired to be picked up.

Note that for the effect described in the present description, contents of the present disclosure are not limited.

The present disclosure can also adopt the below-described configurations.

(1)

A signal processing apparatus including

a directivity processing unit which acquires sound signals of a plurality of channels, the sound signals being concurrently picked up by a microphone array being constituted of a plurality of microphones, the directivity processing unit generating sound signals for varying directivity by using the acquired sound signals of the plurality of channels, a number of the sound signals for varying the directivity being smaller than a number of the channels, directional characteristics of the sound signals for varying the directivity being different from each other.

(2)

The signal processing apparatus according to (1), further including

a directivity variable unit which acquires the sound signals for varying the directivity, the sound signals being generated by the directivity processing unit, synthesizes the acquired sound signals for varying the directivity at a predetermined ratio, and generates a sound signal having a directional characteristic in accordance with the ratio.

(3)

The signal processing apparatus according to (2), in which the directivity variable unit synthesizes sound signals for varying the directivity at the predetermined ratio, directivity patterns of the sound signals for varying the directivity being different from each other.

(4)

The signal processing apparatus according to (2), in which

the directivity variable unit synthesizes sound signals for varying the directivity at the predetermined ratio, directivity patterns of the sound signals for varying the directivity being same as each other.

(5)

The signal processing apparatus according to (2), in which

the directivity variable unit synthesizes sound signals for varying the directivity at the predetermined ratio, directivity angles of the sound signals for varying the directivity being different from each other.

(6)

The signal processing apparatus according to (5), in which

the sound signals for varying the directivity are sound signals corresponding to right and left sound channels, the directivity angles of the sound signals for varying the directivity being different from each other.

(7)

The signal processing apparatus according to (2), in which

the directivity processing unit generates sound signals of four channels, and

by synthesizing sound signals of two channels among the sound signals of the four channels at the predetermined ratio, the directivity variable unit generates an L channel sound signal which has a directional characteristic in accordance with the ratio, and by synthesizing sound signals of two channels being different from the sound signals of the two channels at the predetermined ratio, the directivity variable unit generates an R channel sound signal which has a directional characteristic in accordance with the ratio.

(8)

The signal processing apparatus according to any one of (1) to (7), further including

a recording unit which records, in a recording medium, the sound signals for varying the directivity being generated by the directivity processing unit.

(9)

The signal processing apparatus according to any one of (2) to (7), further including

a reproducing unit which reproduces the sound signals being generated by the directivity variable unit.

(10)

The signal processing apparatus according to any one of (2) to (9), in which

the predetermined ratio is made changeable in real time. (11)

The signal processing apparatus according to any one of (1) to (10), in which

the sound signals for varying the directivity are sound signals to change at least one of directivity sharpness or a directional main axis.

(12)

The signal processing apparatus according to any one of (1) to (11), in which

the plurality of microphones has characteristics which are same as one another. (13)

The signal processing apparatus according to any one of (1) to (12), in which

the directivity processing unit generates, as the sound signals for varying the directivity, sound signals of two channels or sound signals of four channels.

(14)

The signal processing apparatus according to any one of (1) to (13), further including

the plurality of microphones. (15)

A signal processing apparatus including:

an input unit to which sound signals for varying directivity are inputted, the sound signals being generated by using sound signals of a plurality of channels, the sound signals of the plurality of channels being concurrently picked up by a microphone array being constituted of a plurality of microphones, a number of the sound signals for varying the directivity being smaller than a number of the channels, directional characteristics of the sound signals for varying the directivity being different from each other; and

a directivity variable unit which synthesizes the sound signals for varying the directivity being inputted to the input unit at a predetermined ratio and generates a sound signal having directivity in accordance with the ratio.

(16)

A signal processing method in which

a directivity processing unit acquires sound signals of a plurality of channels, the sound signals of the plurality of channels being concurrently picked up by a microphone array being constituted of a plurality of microphones, and generates sound signals for varying directivity by using the acquired sound signals of the plurality of channels, a number of the sound signals for varying the directivity being smaller than a number of the channels, directional characteristics of the sound signals for varying the directivity being different from each other.

(17)

A program which causes a computer to execute a signal processing method in which

a directivity processing unit acquires sound signals of a plurality of channels, the sound signals of the plurality of channels being concurrently picked up by a microphone array being constituted of a plurality of microphones, and generates sound signals for varying directivity by using the acquired sound signals of the plurality of channels, a number of the sound signals for varying the directivity being smaller than a number of the channels, directional characteristics of the sound signals for varying the directivity being different from each other.

(18)

A directivity variable system including:

a directivity processing unit which acquires sound signals of a plurality of channels, the sound signals being concurrently picked up by a microphone array being constituted of a plurality of microphones, the directivity processing unit generating sound signals for varying directivity by using the acquired sound signals of the plurality of channels, a number of the sound signals for varying the directivity being smaller than a number of the channels, directional characteristics of the sound signals for varying the directivity being different from each other;

a recording unit which records, in a recording medium, the sound signals for varying the directivity being generated by the directivity processing unit;

a directivity variable unit which acquires the sound signals for varying the directivity being read out from the recording medium, synthesizes the acquired sound signals for varying the directivity at a predetermined ratio, and generates a sound signal having directivity in accordance with the ratio; and

a reproducing unit which reproduces the sound signal being generated by the directivity variable unit.

### 3. Application Example

The technology according to the present disclosure can be applied to a variety of products. For example, the technology according to the present disclosure may be applied to an operation room system.

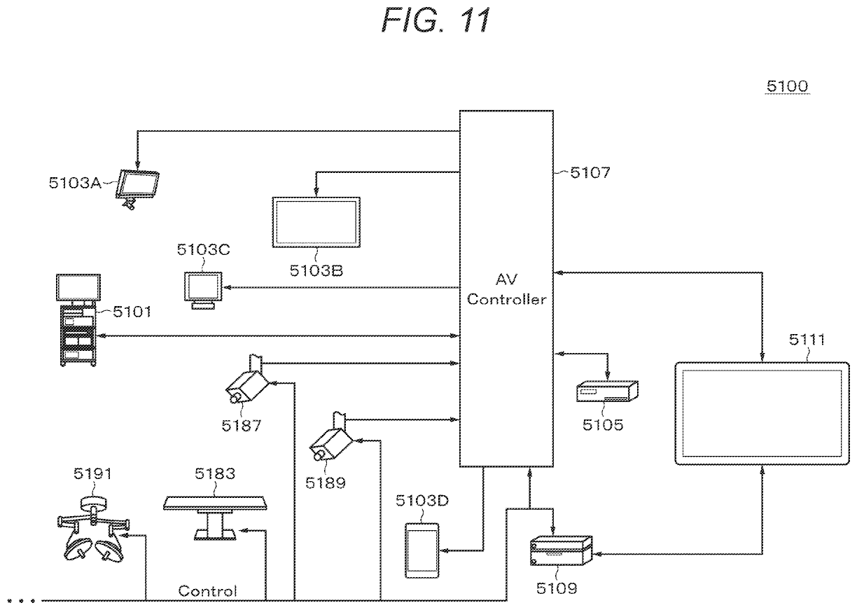

FIG. 11 is a diagram schematically illustrating an overall configuration of an operation room system 5100 to which the technology according to the present disclosure can be applied. With reference to FIG. 11, the operation room system 5100 is configured such that apparatuses in an apparatus group installed in an operation room are connected via an audio-visual controller (AV Controller) 5107 and an operation room control apparatus 5109 in a mutually cooperative manner.

Various apparatuses can be installed in the operation room. In FIG. 11, as one example, an apparatus group 5101 for an operation under an endoscope, a ceiling camera 5187 which is provided on a ceiling of the operation room and captures an image of hands of an operator, an operation site camera 5189 which is provided on the ceiling of the operation room and captures an image of a view of the whole operation room, a plurality of display apparatuses 5103A to 5103D, a recorder 5105, a patient bed 5183, and a lighting apparatus 5191 are illustrated.

Here, among these apparatuses, the apparatus group 5101 belongs to a later-described endoscope operation system 5113 and is constituted of an endoscope, a display apparatus which displays images captured by the endoscope, and the like. The apparatuses which belong to the endoscope operation system 5113 are also referred to as medical apparatuses. On the other hand, the display apparatuses 5103A to 5103D, the recorder 5105, the patient bed 5183, and the lighting apparatus 5191 are, for example, apparatuses which are furnished in the operation room, separately from the endoscope operation system 5113. These apparatuses which do not belong to the endoscope operation system 5113 are also referred to as non-medical apparatuses. The audio-visual controller 5107 and/or the operation room control apparatus 5109 control/controls operations of these medical apparatuses and non-medical apparatuses in a mutually cooperative manner.

The audio-visual controller 5107 comprehensively controls processing relating to image display for the medical apparatuses and the non-medical apparatuses. Specifically, among the apparatuses which the operation room system 5100 includes, the apparatus group 5101, the ceiling camera 5187, and the operation site camera 5189 can be apparatuses (hereinafter, also referred to as transmission source apparatuses), each of which has a function to transmit information which should be displayed during an operation (hereinafter, also referred to as display information). In addition, the display apparatuses 5103A to 5103D can be apparatuses to which the display information is outputted (hereinafter, also referred to as output destination apparatuses). In addition, the recorder 5105 can be an apparatus which corresponds to both of the transmission source apparatuses and the output destination apparatuses. The audio-visual controller 5107 controls operations of the transmission source apparatuses and the output destination apparatuses and has a function to acquire the display information from the transmission source apparatuses, transmit the display information to the output destination apparatuses, and cause the output destination apparatuses to display or record the display information. Note that pieces of the display information are various images captured during an operation, a variety of pieces of information pertinent to an operation (for example, physical information of a patient, past test results, information as to an operative method, and the like), and the like.

Specifically, as the display information, information pertinent to images of an operative site in a body cavity of a patient, which are captured by the endoscope, can be transmitted from the apparatus group 5101 to the audio-visual controller 5107. In addition, as the display information, information pertinent to images of hands of an operator, which are captured by the ceiling camera 5187, can be transmitted from the ceiling camera 5187. In addition, as the display information, information pertinent to images showing a view of the whole operation room, which are captured by the operation site camera 5189, can be transmitted from the operation site camera 5189. Note that in a case where other apparatuses, each of which has a function to capture images, are present in the operation room system 5100, as the display information, the audio-visual controller 5107 may acquire information pertinent to images, which are captured by the other apparatuses, also from the other apparatuses.

Alternatively, for example, in the recorder 5105, the information pertinent to these images captured in the past is recorded by the audio-visual controller 5107. As the display information, the audio-visual controller 5107 can acquire the information pertinent to the images captured in the past from the recorder 5105. Note that in the recorder 5105, a variety of pieces of information pertinent to an operation may also be previously recorded.

The audio-visual controller 5107 causes at least any of the display apparatuses 5103A to 5103D as the output destination apparatuses to display the acquired display information (that is, the images shot during an operation or a variety of pieces of information pertinent to the operation). In an illustrated example, the display apparatus 5103A is a display apparatus which is suspended from the ceiling of the operation room and installed, the display apparatus 5103B is a display apparatus which is installed on a wall surface of the operation room, the display apparatus 5103C is a display apparatus which is installed on a desk in the operation room, and the display apparatus 5103D is a mobile device having a display function (for example, a tablet personal computer (PC)).

In addition, although illustration is omitted in FIG. 11, the operation room system 5100 may include apparatuses outside the operation room. The apparatuses outside the operation room can be, for example, a server connected to a network which is constructed inside or outside a hospital, PCs used by a medical staff, a projector which is installed in a meeting room of a hospital, and the like. In a case where the external apparatuses as described above are present outside a hospital, for remote medicine, the audio-visual controller 5107 can also cause display apparatuses of other hospital to display the display information via a teleconference system or the like.

The operation room control apparatus 5109 comprehensively controls processing other than the processing as to image display of the non-medical apparatuses. For example, the operation room control apparatus 5109 controls driving of the patient bed 5183, the ceiling camera 5187, the operation site camera 5189, and the lighting apparatus 5191.

The operation room system 5100 is provided with a central operation panel 5111, and a user can issue an instruction as to image display to the audio-visual controller 5107 via the central operation panel 5111 and can issue an instruction as to operations of the non-medical apparatuses to the operation room control apparatus 5109. The central operation panel 5111 is configured by providing a touch panel on the display screen of the display apparatus.

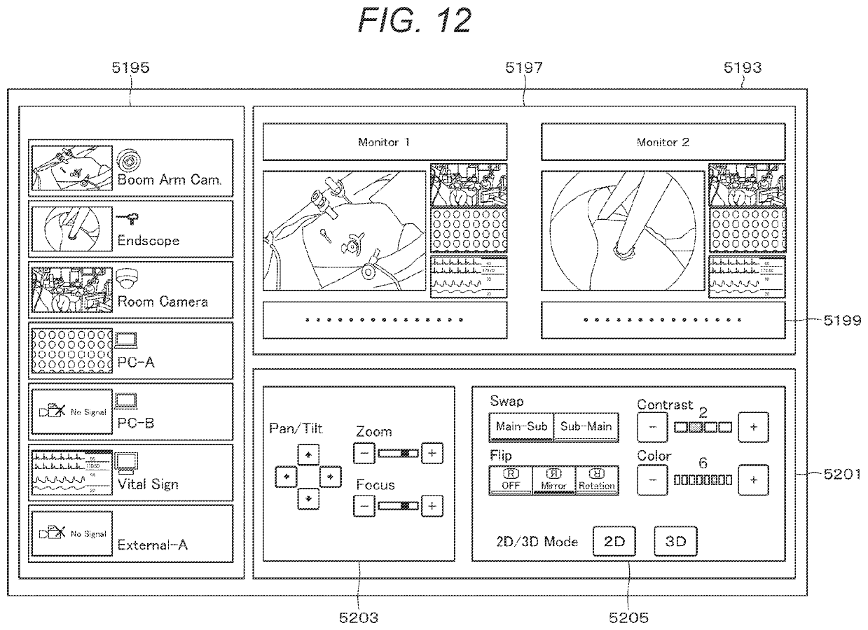

FIG. 12 is a diagram illustrating a display example of an operation screen of the central operation panel 5111. In FIG. 12, as one example, an operation screen which copes with a case where the operation room system 5100 is provided with two display apparatuses as the output destination apparatuses is illustrated. With reference to FIG. 12, an operation screen 5193 is provided with a transmission source selection region 5195, a preview region 5197, and a control region 5201.

In the transmission source selection region 5195, a transmission source apparatus which is provided in the operation room system 5100 and a thumbnail screen on which display information which the transmission source apparatus has is shown are displayed in a linked manner. A user can select display information, which is desired to be displayed on the display apparatus, from any of the transmission source apparatuses displayed in the transmission source selection region 5195.

In the preview region 5197, previews of screens displayed on the two display apparatuses (Monitor 1 and Monitor 2) as the output destination apparatuses are displayed. In an illustrated example, on each one of the display apparatuses, four images are PinP-displayed. The four images correspond to pieces of display information which are transmitted from the transmission source apparatus selected in the transmission source selection region 5195. One of the four images is displayed in a comparatively large manner as a main image, and the remaining three images are displayed in a comparatively small manner as sub-images. A user appropriately selects any of regions where the four images are displayed, thereby allowing the user to switch between the main image and the sub-images. In addition, below the regions where the four images are displayed, a status display region 5199 is provided, and in the region, statuses relating to an operation (for example, elapsed time in the operation, physical information of a patient, and the like) can be appropriately displayed.

The control region 5201 is provided with a transmission source operation region 5203 where graphical user interface (GUI) components for operating the transmission source apparatuses are displayed and an output destination operation region 5205 where GUI components for operating the output destination apparatuses are displayed. In the illustrated example, in the transmission source operation region 5203, GUI components for causing the cameras of the transmission source apparatuses each having an imaging function to perform various kinds of operations (panning, tilting, and zooming) are provided. A user appropriately selects any of these GUI components, thereby allowing the user to operate operations of the cameras of the transmission source apparatuses. Note that although illustration is omitted, in a case where the transmission source apparatus selected in the transmission source selection region 5195 is the recorder (that is, a case where in the preview region 5197, images recorded in the past are displayed in the recorder), in the transmission source operation region 5203, GUI components for performing operations such as reproduction of the images, reproduction stop, rewind, fast-forward, and the like can be provided.

In addition, in the output destination operation region 5205, GUI components for performing various kinds of operations (swap, flip, color adjustment, contrast adjustment, and switch between 2D display and 3D display) of the display apparatuses as the output destination apparatuses are provided. A user appropriately selects any of these GUI components, thereby allowing the user to operate the display on the display apparatuses.

Note that the operation screen displayed on the central operation panel 5111 is not limited to the illustrated example, it may be possible for a user to input operations to the apparatuses which can be controlled by the audio-visual controller 5107 and the operation room control apparatus 5109, which are provided in the operation room system 5100, via the central operation panel 5111.

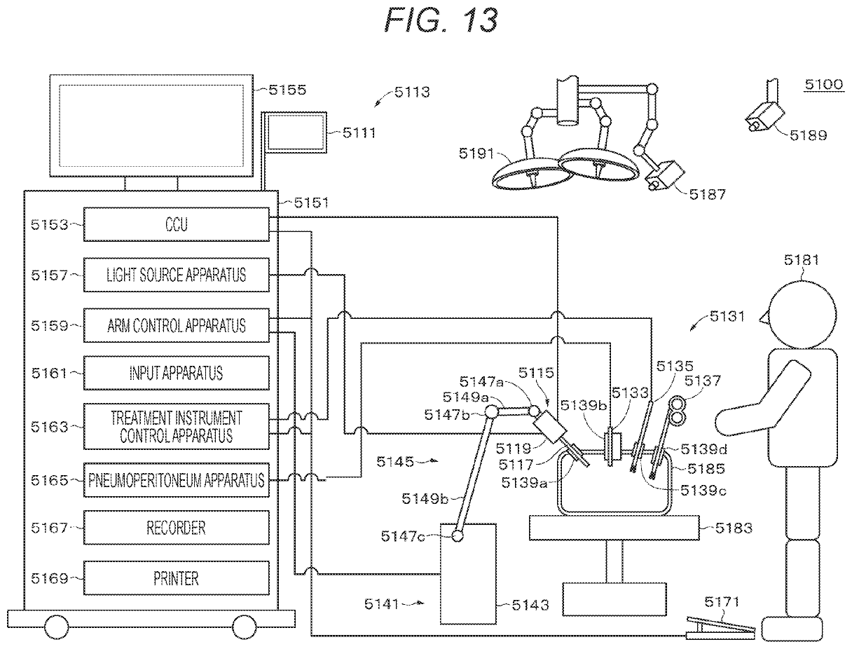

FIG. 13 is a diagram illustrating one example of a view of an operation in which the above-described operation room system is applied. The ceiling camera 5187 and the operation site camera 5189 are provided on the ceiling of the operation room and are operable to shoot hands of an operator (surgeon) 5181 who performs treatment for an affected area of a patient 5185 on the patient bed 5183 and a view of the whole operation room. Each of the ceiling camera 5187 and the operation site camera 5189 can be provided with a magnification adjustment function, a focal distance adjustment function, a shooting direction adjustment function, and the like. The lighting apparatus 5191 is provided on the ceiling of the operation room and irradiates the hands of at least operator 5181. It may be possible to appropriately adjust an irradiation light amount, a wavelength (color) of irradiation light, an irradiation direction of light, and the like of the lighting apparatus 5191.

The endoscope operation system 5113, the patient bed 5183, the ceiling camera 5187, the operation site camera 5189, and the lighting apparatus 5191 are connected in a mutually linkable manner via the audio-visual controller 5107 and the operation room control apparatus 5109 (which are not illustrated in FIG. 13) as illustrated in FIG. 11. In the operation room, the central operation panel 5111 is provided, and as described above, a user can appropriately operate these apparatuses, which are present in the operation room, via the central operation panel 5111.

Hereinafter, a configuration of the endoscope operation system 5113 will be described in detail. As illustrated, the endoscope operation system 5113 is constituted of an endoscope 5115, other operation instruments 5131, a support arm apparatus 5141 which supports the endoscope 5115, and a cart 5151 on which various kinds of apparatuses for an operation under an endoscope are mounted.

In an endoscope operation, instead of performing laparotomy by cutting an abdominal wall, the abdominal wall is punctured by a plurality of tubular opening instruments, which is referred to as trocars 5139a to 5139d. Then, from the trocars 5139a to 5139d, a lens barrel 5117 of the endoscope 5115 and the other operation instruments 5131 are inserted into a body cavity of the patient 5185. In an illustrated example, as the other operation instruments 5131, a pneumoperitoneum tube 5133, an energy treatment instrument 5135, and forceps 5137 are inserted into the body cavity of the patient 5185. In addition, the energy treatment instrument 5135 is a treatment instrument which sections and exfoliates tissues, seals a blood vessel, or performs other treatment by a high frequency current or ultrasonic vibration. However, the illustrated operation instruments 5131 are merely instruments in one example, and as the operation instruments 5131, for example, various kinds of operation instruments, such as tweezers and a retractor, which are used in the operation under an endoscope in general may be used.

Images of an operative site inside the body cavity of the patient 5185, which have been shot by the endoscope 5115, are displayed on a display apparatus 5155. While looking at the images of the operative site displayed on the display apparatus 5155 in real time, the operator 5181 performs, for example, treatment such as ablation of an affected area by using the energy treatment instrument 5135 and the forceps 5137. Note that although illustration is omitted, the pneumoperitoneum tube 5133, the energy treatment instrument 5135, and the forceps 5137 are supported by the operator 5181, assistants, or the like during the operation.

(Support Arm Apparatus)

The support arm apparatus 5141 includes an arm part 5145 which extends from a base part 5143. In the illustrated example, the arm part 5145 is constituted of joint parts 5147a, 5147b, and 5147c and links 5149a and 5149b and is driven by control from an arm control apparatus 5159. The endoscope 5115 is supported by the arm part 5145, and a position and a posture are controlled. Thus, stable fixing of the position of the endoscope 5115 can be realized.

(Endoscope)

The endoscope 5115 is constituted of the lens barrel 5117 whose area having a predetermined length from a leading end thereof is inserted into the body cavity of the patient 5185 and a camera head 5119 which is connected to a base end of the lens barrel 5117. Although in the illustrated example, the endoscope 5115 which has a rigid lens barrel 5117 and is configured as the so-called rigid scope is illustrated, the endoscope 5115 may be configured as the so-called flexible scope having a flexible lens barrel 5117.

At the leading end of the lens barrel 5117, an opening part in which an objective lens is embedded is provided. A light source apparatus 5157 is connected to the endoscope 5115, and light generated by the light source apparatus 5157 is guided up to the leading end of the lens barrel by a light guide which is extended inside the lens barrel 5117 and is emitted toward an observation target inside the body cavity of the patient 5185 via the objective lens. Note that the endoscope 5115 may be a forward-viewing endoscope, an oblique-viewing endoscope, or a side-viewing endoscope.

Inside the camera head 5119, an optical system and an image sensor are provided, reflected light (observation light) from the observation target is collected to the image sensor by the optical system. The observation light is photoelectrically converted by the image sensor, and an electrical signal corresponding to the observation light, that is, an image signal corresponding to an observation image is generated. The image signal is transmitted as RAW data to a camera control unit (CCU) 5153. Note that the camera head 5119 is provided with a function to adjust a magnification and a focal distance, which is performed by appropriately driving the optical system.

Note that for example, in order to cope with a stereoscopic view (3D display), the camera head 5119 may be provided with a plurality of image sensors. In this case, inside the lens barrel 5117, in order to guide the observation light to the plurality of image sensors, a plurality of relay optical systems is provided.

(Various Kinds of Apparatuses Mounded on Cart)

The CCU 5153 is constituted of a central processing unit (CPU), a graphics processing unit (GPU), or the like and comprehensively controls operations of the endoscope 5115 and the display apparatus 5155. Specifically, the CCU 5153 subjects an image signal received from the camera head 5119 to, for example, various kinds of image processing such as development processing (demosaic processing) to display an image based on the image signal. The CCU 5153 provides the image signal subjected to the image processing for the display apparatus 5155. In addition, the audio-visual controller 5107 illustrated in FIG. 11 is connected to the CCU 5153. The CCU 5153 provides the image signal subjected to the image processing also for the audio-visual controller 5107. In addition, the CCU 5153 transmits a control signal to the camera head 5119 and controls driving thereof. The control signal can include information pertinent to imaging conditions such as a magnification and a focal distance. The information pertinent to the imaging conditions may be inputted via an input apparatus 5161 or may be inputted via the above-described central operation panel 5111.

By the control from the CCU 5153, the display apparatus 5155 displays the image based on the image signal subjected to the image processing by the CCU 5153. In a case where the endoscope 5115 copes with, for example, shooting at a high resolution such as 4K (3840 (a number of horizontal pixels)×2160 (a number of vertical pixels)) or 8K (7680 (a number of horizontal pixels)×4320 (a number of vertical pixels)) and/or the endoscope 5115 copes with 3D display, as the display apparatus 5155, a display apparatus which is operable to perform display at the high resolution and/or a display apparatus which is operable to perform the 3D display are/is used. In a case where the endoscope 5115 copes with the shooting at the high resolution such as 4K or 8K, as the display apparatus 5155, a display apparatus having a size of 55 or more inches is used, thereby obtaining feeling of further immersion. In addition, in accordance with applications, a plurality of display apparatuses 5155 whose resolutions and sizes are different from each other may be provided.

The light source apparatus 5157 is constituted of a light source, for example, light emitting diodes (LED) or the like and supplies, to the endoscope 5115, irradiation light upon shooting the operative site.

The arm control apparatus 5159 is constituted of, for example, a processor such as a CPU and operates in accordance with a predetermined program, thereby controlling driving of the arm part 5145 of the support arm apparatus 5141 in accordance with a predetermined control method.

The input apparatus 5161 is an input interface for the endoscope operation system 5113. A user can input various pieces of information and instructions to the endoscope operation system 5113 via the input apparatus 5161. For example, a user inputs various pieces of information relating to an operation such as physical information of a patient and information pertinent an operative procedure of an operation via the input apparatus 5161. In addition, a user inputs, for example, an instruction to drive the arm part 5145, an instruction to change the imaging conditions (a kind of irradiation light, a magnification, a focal distance, and the like) by the endoscope 5115, an instruction to drive the energy treatment instrument 5135, and other instruction via the input apparatus 5161.

A kind of the input apparatus 5161 is not limited, and the input apparatus 5161 may be each of various kinds of the heretofore known input apparatuses. As the input apparatus 5161, for example, a mouse, a keyboard, a touch panel, switches, a foot switch 5171, and/or a lever, and the like can be applied. In a case where as the input apparatus 5161, the touch panel is used, the touch panel may be provided on a display surface of the display apparatus 5155.

Alternatively, the input apparatus 5161 is, for example, a device, such as an eyeglass-type wearable device and a head mounted display (HMD), which is worn by a user, and in accordance with gesture and a line-of-sight of a user, which are detected by each of these devices, various kinds of input are performed. In addition, the input apparatus 5161 includes a camera which can detect movement of a user, and in accordance with the gesture and the line-of-sight of a user which are detected from images captured by the camera, various kinds of input are performed. Furthermore, the input apparatus 5161 includes a microphone which can pick up voice of a user, and various kinds of input are performed via the microphone by sound. As described above, the input apparatus 5161 is configured such that various pieces of information can be input in a non-contact manner, thereby allowing a user belonging to a clean area in particular (for example, the operator 5181) to operate instruments belonging to an unclean area in the non-contact manner. In addition, since it is made possible for a user to operate an instrument without disengaging a hand or hands from an operation instrument which a user has, convenience of a user is enhanced.

The treatment instrument control apparatus 5163 controls driving of the energy treatment instrument 5135 for cauterization and section of tissues, sealing of a blood vessel, and the like. For the purposes of securement of a field of view by the endoscope 5115 and securement of a work space for an operator, in order to inflate the body cavity of the patient 5185, the pneumoperitoneum apparatus 5165 sends gas into the body cavity via the pneumoperitoneum tube 5133. The recorder 5167 is an apparatus which can record various pieces of information relating to an operation. A printer 5169 is an apparatus which can print the various pieces of information relating to the operation in various formats such as text, images, or graphs.

Hereinafter, particularly characteristic configurations in the endoscope operation system 5113 will be described in further detail.

(Support Arm Apparatus)

The support arm apparatus 5141 includes the base part 5143 as a base and the arm part 5145 which extends from the base part 5143. In the illustrated example, although the arm part 5145 is constituted of a plurality of the joint parts 5147a, 5147b, and 5147c and a plurality of the links 5149a and 5149b which is coupled by the joint part 5147b, in FIG. 13, for the sake of simplification, a configuration of the arm part 5145 is illustrated in a simplified manner. In reality, in order for the arm part 5145 to have a desired degree of freedom, shapes, numbers, and arrangement of the joint parts 5147a to 5147c and the links 5149a and 5149b, directions of rotation axes of the joint parts 5147a to 5147c, and the like can be appropriately set. For example, suitably, the arm part 5145 can be configured so as to have six or more degrees of freedom. Thus, since it is made possible to freely move the endoscope 5115 within a movable range of the arm part 5145, it is made possible to insert the lens barrel 5117 of the endoscope 5115 into the body cavity of the patient 5185 from a desired direction.

Each of the joint parts 5147a to 5147c is provided with an actuator, and each of the joint parts 5147a to 5147c is configured in such a way as to be rotatable around a predetermined rotation axis by driving of the actuator. The driving of the actuator is controlled by the arm control apparatus 5159, thereby controlling a rotation angle of each of the joint parts 5147a to 5147c and controlling driving of the arm part 5145. Thus, control of a position and a posture of the endoscope 5115 can be realized. At this time, the arm control apparatus 5159 can control the driving of the arm part 5145 by a variety of the heretofore known control methods for force control, position control, or the like.

For example, the operator 5181 appropriately inputs an operation via the input apparatus 5161 (including the foot switch 5171), whereby in accordance with the input of the operation, the driving of the arm part 5145 may be appropriately controlled by the arm control apparatus 5159 and the position and the posture of the endoscope 5115 may be controlled. By the above-mentioned control, the endoscope 5115 at a leading end of the arm part 5145 is moved from any position to another any position, and thereafter, the endoscope 5115 can be fixedly supported in the position after the movement. Note that the arm part 5145 may be operated by the so-called master-slave method. In this case, the arm part 5145 can be remotely operated by a user via the input apparatus 5161 which is installed in a place away from the operation room.

In addition, in a case where the force control is applied, the arm control apparatus 5159 may perform the so-called power assist control in which the actuator of each of the joint parts 5147a to 5147c is driven such that an external force is received from a user and following the external force, the arm part 5145 smoothly moves. Thus, when the arm part 5145 is moved while a user is directly touching the arm part 5145, the arm part 5145 can be moved by a comparatively light force. Accordingly, it is made possible to move the endoscope 5115 by a further simple operation in an intuitive manner, thereby allowing convenience for a user to be enhanced.

Here, in general, in the operation under an endoscope, the endoscope 5115 is supported by a surgeon referred to as a scopist. In contrast to this, since by using the support arm apparatus 5141, the position of the endoscope 5115 can be further surely fixed without manpower, images of an operative site can be stably obtained, thereby allowing the operation to be smoothly performed.

Note that it is not necessarily required for the arm control apparatus 5159 to be provided for the cart 5151. In addition, it is not necessarily required for the arm control apparatus 5159 to be constituted of one apparatus. For example, the arm control apparatus 5159 may be provided for each of the joint parts 5147a to 5147c of the arm part 5145 of the support arm apparatus 5141, and a plurality of arm control apparatuses 5159 may operate in a mutually collaborative manner, and driving control of the arm part 5145 may be thereby realized.

(Light Source Apparatus)

The light source apparatus 5157 supplies irradiation light to the endoscope 5115 upon shooting the operative site. The light source apparatus 5157 is constituted of a white light source which is configured by, for example, LEDs, a laser light source, or a combination of these. At this time, in a case where the white light source is configured with RGB laser light sources combined, since an output intensity and output timing of each of colors (each wavelength) can be controlled at high accuracy, in the light source apparatus 5157, white balance of captured images can be adjusted. In addition, in this case, an observation target is irradiated with laser light from each of the RGB laser light sources in a time-division manner, and in synchronization with irradiation timing thereof, driving of an image sensor of the camera head 5119 is controlled, thereby also making it possible to capture images which respectively correspond to the RGB in a time-division manner. By employing the above-described method, color images can be obtained even without providing color filters for the image sensor.

In addition, driving of the light source apparatus 5157 may be controlled such that an intensity of outputted light is changed each predetermined time. In synchronization with timing at which the intensity of outputted light is changed, the driving of the image sensor of the camera head 5119 is controlled, images are acquired in a time-division manner, and the images are synthesized, thereby allowing high dynamic range images without the so-called blocked-up shadows and blown-out highlights to be generated.

In addition, the light source apparatus 5157 may be configured to be capable of supplying light in a predetermined wavelength band, which copes with special light observation. In the special light observation, for example, performed is the so-called narrow band light observation (Narrow Band Imaging) in which by utilizing wavelength dependency of absorption of light on body tissues, light in a narrow band, as compared with irradiation light in normal observation (that is, white light), is emitted, and predetermined tissues such as a blood vessel of a mucous membrane superficial layer is thereby shot at high contrast. Alternatively, in the special light observation, fluorescence observation in which images are obtained by fluorescence generated by emitting excitation light may be performed. As the fluorescence observation, fluorescence observation (self-fluorescence observation) in which body tissues are irradiated with the excitation light and fluorescence from the body tissues is observed, fluorescence observation in which a reagent such as indocyanine green (ICG) is locally injected to the body tissues and the body tissues are irradiated with excitation light which corresponds to a fluorescence wavelength of the reagent and fluorescence images are obtained, or other fluorescence observation can be performed. The light source apparatus 5157 can be configured to be capable of supplying the narrow band light which copes with the above-mentioned special light observation and/or the excitation light.

(Camera Head and CCU)

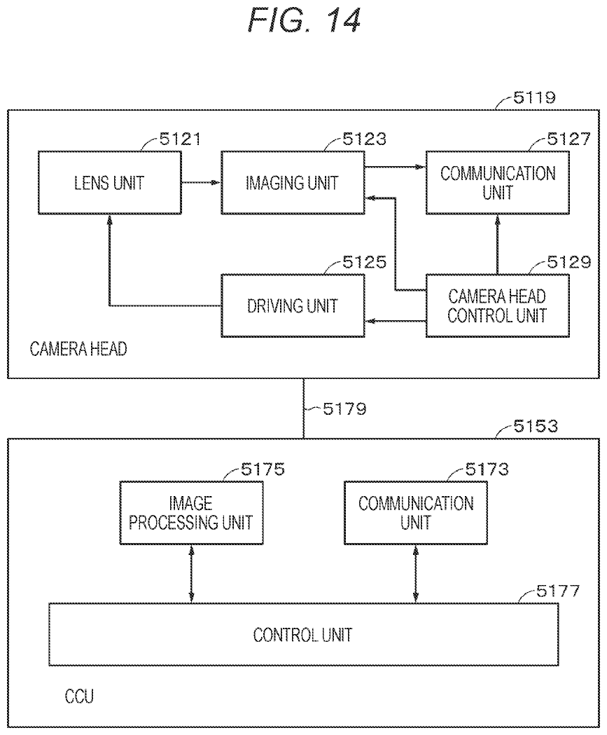

With reference to FIG. 14, functions of the camera head 5119 and the CCU 5153 of the endoscope 5115 will be described in further detail. FIG. 14 is a block diagram illustrating one example of a function configuration of each of the camera head 5119 and the CCU 5153 illustrated in FIG. 13.

With reference to FIG. 14, the camera head 5119 has a lens unit 5121, an imaging unit 5123, a driving unit 5125, a communication unit 5127, and a camera head control unit 5129 as functions thereof. In addition, the CCU 5153 has a communication unit 5173, an image processing unit 5175, and a control unit 5177 as functions thereof. The camera head 5119 and the CCU 5153 are connected by a transmission cable 5179 in an interactively communicable manner.

First, a function configuration of the camera head 5119 will be described. The lens unit 5121 is an optical system which is provided in a connection part with the lens barrel 5117. Observation light taken in from a leading end of the lens barrel 5117 is guided up to the camera head 5119 and enters the lens unit 5121. The lens unit 5121 is configured by combining a plurality of lenses which includes a zoom lens and a focus lens. Optical characteristics of the lens unit 5121 are adjusted such that observation light is collected onto a light receiving surface of the image sensor of the imaging unit 5123. In addition, for adjustment of a magnification and a focal point of a captured image, the zoom lens and the focus lens are configured such that positions of the zoom lens and the focus lens on an optical axis are movable.

The imaging unit 5123 is constituted of the image sensor and is located on a stage subsequent to the lens unit 5121. The observation light which has passed through the lens unit 5121 is collected onto the light receiving surface of the image sensor, and an image signal which corresponds to the observation image is generated by photoelectric conversion. The image signal generated by the imaging unit 5123 is provided for the communication unit 5127.

As the image sensor of which the imaging unit 5123 is constituted, for example, an image sensor which is a complementary metal oxide semiconductor (CMOS) type, has Bayer arrangement, and is capable of performing color shooting is used. Note that as the image sensor, for example, an image sensor which can cope with shooting of images each having a high resolution of 4K or more may be used. Images of the operative site at the high resolution are obtained, thereby allowing the operator 5181 to comprehend a view of the operative site in further detail and to further smoothly advance an operation.

In addition, the image sensor of which the imaging unit 5123 is constituted is configured in such a way as to have a pair of image sensors for acquiring image signals for a right eye and a left eye, which cope with 3D display. By performing the 3D display, the operator 5181 can accurately comprehend depth of body tissues of the operative site. Note that in a case where the imaging unit 5123 is configured to be a multi-plate type, a plurality of systems of lens units 5121 is also provided to correspond to the image sensors.

In addition, it is not necessarily required for the imaging unit 5123 to be provided for the camera head 5119. For example, the imaging unit 5123 may be provided inside the lens barrel 5117 and immediately behind the objective lens.

The driving unit 5125 is configured by an actuator and moves the zoom lens and the focus lens of the lens unit 5121 along the optical axis by a predetermined distance by control from the camera head control unit 5129. Thus, a magnification and a focal point of an image captured by the imaging unit 5123 can be appropriately adjusted.

The communication unit 5127 is configured by a communication apparatus for transmitting and receiving various pieces of information to and from the CCU 5153. The communication unit 5127 transmits the image signals obtained from the imaging unit 5123 as RAW data via the transmission cable 5179 to the CCU 5153. At this time, it is preferable that the image signals are transmitted by optical communication in order to display the captured image of the operative site with low latency. This is because since upon performing the operation, the operator 5181 performs the operation while observing a condition of an affected area by the captured image, it is demanded that a moving image of the operative site be displayed in real time as far as possible for a further safe and secure operation. In a case where the optical communication is performed, the communication unit 5127 is provided with a photoelectric conversion module which converts an electrical signal to an optical signal. The image signal is converted to the optical signal by the photoelectric conversion module and thereafter, the optical signal is transmitted via the transmission cable 5179 to the CCU 5153.

In addition, the communication unit 5127 receives, from the CCU 5153, a control signal to control driving of the camera head 5119. The control signal includes, for example, information relating to imaging conditions, such as information that a frame rate of the captured image is designated, information that an exposure value upon capturing an image is designated, and/or information that a magnification and a focal point of the captured image are designated. The communication unit 5127 provides the received control signal for the camera head control unit 5129. Note that the control signal from the CCU 5153 may also be transmitted by the optical communication. In this case, the communication unit 5127 is provided with a photoelectric conversion module which converts an optical signal to an electrical signal, the control signal is converted to the electrical signal by the photoelectric conversion module, and thereafter, the electrical signal is provided for the camera head control unit 5129.

Note that the imaging conditions such as the above-mentioned frame rate, exposure value, magnification, and focal point are automatically set by the control unit 5177 of the CCU 5153 on the basis of the obtained image signal. In other words, the so-called auto exposure (AE) function, auto focus (AF) function, auto white balance (AWB) function are mounted on the endoscope 5115.

On the basis of the control signal received via the communication unit 5127 from the CCU 5153, the camera head control unit 5129 controls the driving of the camera head 5119. For example, on the basis of the information that the frame rate of the captured image is designated and/or information that exposure upon capturing an image is designated, the camera head control unit 5129 controls the driving of the image sensors of the imaging unit 5123. In addition, for example, on the basis of the information that the magnification and the focal point of the captured image are designated, the camera head control unit 5129 appropriately moves the zoom lens and the focus lens of the lens unit 5121 via the driving unit 5125. The camera head control unit 5129 may further have a function to store information for identifying the lens barrel 5117 and the camera head 5119.

Note that the lens unit 5121, the imaging unit 5123, and the like are located inside a sealing structure which is highly airtight and highly waterproof, thereby allowing the camera head 5119 to have resistance against autoclave sterilization processing.

Next, a function configuration of the CCU 5153 will be described. The communication unit 5173 is configured by a communication apparatus for transmitting and receiving various pieces of information to and from the camera head 5119. The communication unit 5173 receives, from the camera head 5119, an image signal transmitted via the transmission cable 5179. At this time, as mentioned above, the image signal can be suitably transmitted by the optical communication. In this case, the communication unit 5173 is provided with a photoelectric conversion module, which converts an optical signal to an electrical signal, in order to cope with the optical communication. The communication unit 5173 provides the image signal, which has been converted to the electrical signal, for the image processing unit 5175.

In addition, the communication unit 5173 transmits a control signal for controlling the driving of the camera head 5119 to the camera head 5119. The control signal may also be transmitted by the optical communication.

The image processing unit 5175 subjects the image signal transmitted from the camera head 5119 as RAW data to various kinds of image processing. The image processing includes, for example, various kinds of the heretofore known signal processing such as development processing, image quality enhancing processing (band emphasizing processing, super-resolution processing, noise reduction (NR) processing, and/or hand blur correction processing), and/or enlargement processing (electronic zoom processing). In addition, the image processing unit 5175 performs wave detection processing for the image signal to perform the AE, the AF, and the AWB.

The image processing unit 5175 is configured by a processor such as a CPU and a GPU, and the processor operates in accordance with a predetermined program, whereby the above-described image processing and wave detection processing can be performed. Note that in a case where the image processing unit 5175 is configured by a plurality of GPUs, the image processing unit 5175 appropriately divides information pertinent to the image signal and performs the image processing in parallel by the plurality of GPUs.

The control unit 5177 captures an image of the operative site by the endoscope 5115 and performs various kinds of control relating to display of the captured image. For example, the control unit 5177 generates a control signal for controlling the driving of the camera head 5119. At this time, in a case where imaging conditions are inputted by a user, the control unit 5177 generates the control signal on the basis of the input made by the user. Alternatively, in a case where the AE function, the AF function, and the AWB function are mounted on the endoscope 5115, in accordance with a result of the wave detection processing performed by the image processing unit 5175, the control unit 5177 appropriately calculates an optimum exposure value, an optimum focal distance, and optimum white balance and generates the control signal.

In addition, on the basis of the image signal which has been subjected to the image processing by the image processing unit 5175, the control unit 5177 causes the display apparatus 5155 to display an image of the operative site. At this time, by using various kinds of image recognition technologies, the control unit 5177 recognizes various kinds of objects in the image of the operative site. For example, the control unit 5177 detects a shape, color, and the like of an edge of an object, included in the image of the operative site, thereby allowing the control unit 5177 to recognize operation instruments such as forceps, a specific body site, bleeding, mist upon using the energy treatment instrument 5135, and the like. Upon causing the display apparatus 5155 to display the image of the operative site, by using a result of the recognition, the control unit 5177 causes the display apparatus 5155 to display various pieces of operation support information which are superimposed on the image of the operative site. The operation support information is displayed in a superimposed manner and is presented to the operator 5181, thereby allowing the operator 5181 to further safely and surely advance the operation.

The transmission cable 5179 which connects the camera head 5119 and the CCU 5153 is an electrical signal cable which copes with communication of electrical signals, optical fiber which copes with the optical communication, or a composite cable of these.

Here, although in the illustrated example, wired communication is performed by using the transmission cable 5179, communication between the camera head 5119 and the CCU 5153 may be wirelessly performed. In a case where the communication between the camera head 5119 and the CCU 5153 is wirelessly performed, since it is not required to install the transmission cable 5179 in the operation room, a situation in which movement of a medical staff in the operation room is hindered by the transmission cable 5179 can be eliminated.

Hereinbefore, one example of the operation room system 5100 to which the technology according to the present disclosure can be applied is described. Note that although herein, as one example, a case where a medical system to which the operation room system 5100 is applied is the endoscope operation system 5113 is described, a configuration of the operation room system 5100 is not limited to the above-described example. For example, the operation room system 5100 may be applied to a soft endoscope system for inspection or a micrographic operation system, instead of the endoscope operation system 5113.

The microphone array according to the present disclosure can be suitably applied to the input apparatus 5161 among the above-described configurations. In addition, the signal processing apparatus according to the present disclosure can be suitably applied to the CCU 5153 among the above-described configurations. In a medical field, for example, scenes in which sound signals of instructions of an operator (surgeon) in an operation room, reports, conversation such as messages, communication with voice agents, and the like are recorded together with video signals have been increasing. By applying the present disclosure, directivity is adjusted so as to correspond to a position of the operator which is acquired by previous image recognition or the like, and thereafter, sound signals can be recorded. In addition, directivity is adjusted so as not to record disturbing sound such as sound made by a person which is not concerned, sound of door opening/closing, and noise made by instruments, and thereafter, sound signals can be recorded.

### REFERENCE SIGNS LIST

1 Directivity variable system

2 Microphone array

3 Recording device

4 Recording medium

5 Reproducing device

21(1) to (8) Microphone

31(1) to (8) A/D converter

32 Directivity processing unit

32A First directivity processing unit

32B Second directivity processing unit

33 Recording unit

33A CH1 recording unit

33B CH2 recording unit

Directivity variable unit

Monaural output unit

1. A signal processing apparatus comprising
a directivity processing unit which acquires sound signals of a plurality of channels, the sound signals being concurrently picked up by a microphone array being constituted of a plurality of microphones, the directivity processing unit generating sound signals for varying directivity by using the acquired sound signals of the plurality of channels, a number of the sound signals for varying the directivity being smaller than a number of the channels, directional characteristics of the sound signals for varying the directivity being different from each other.

2. The signal processing apparatus according to claim 1, further comprising
a directivity variable unit which acquires the sound signals for varying the directivity, the sound signals being generated by the directivity processing unit, synthesizes the acquired sound signals for varying the directivity at a predetermined ratio, and generates a sound signal having a directional characteristic in accordance with the ratio.

3. The signal processing apparatus according to claim 2, wherein
the directivity variable unit synthesizes sound signals for varying the directivity at the predetermined ratio, directivity patterns of the sound signals for varying the directivity being different from each other.

4. The signal processing apparatus according to claim 2, wherein
the directivity variable unit synthesizes sound signals for varying the directivity at the predetermined ratio, directivity patterns of the sound signals for varying the directivity being same as each other.

5. The signal processing apparatus according to claim 2, wherein
the directivity variable unit synthesizes sound signals for varying the directivity at the predetermined ratio, directivity angles of the sound signals for varying the directivity being different from each other.

6. The signal processing apparatus according to claim 5, wherein
the sound signals for varying the directivity are sound signals corresponding to right and left sound channels, the directivity angles of the sound signals for varying the directivity being different from each other.

7. The signal processing apparatus according to claim 2, wherein
the directivity processing unit generates sound signals of four channels, and
by synthesizing sound signals of two channels among the sound signals of the four channels at the predetermined ratio, the directivity variable unit generates an L channel sound signal which has a directional characteristic in accordance with the ratio, and by synthesizing sound signals of two channels being different from the sound signals of the two channels at the predetermined ratio, the directivity variable unit generates an R channel sound signal which has a directional characteristic in accordance with the ratio.

8. The signal processing apparatus according to claim 1, further comprising
a recording unit which records, in a recording medium, the sound signals for varying the directivity being generated by the directivity processing unit.

9. The signal processing apparatus according to claim 2, further comprising
a reproducing unit which reproduces the sound signals being generated by the directivity variable unit.

10. The signal processing apparatus according to claim 2, wherein
the predetermined ratio is made changeable in real time.

11. The signal processing apparatus according to claim 1, wherein
the sound signals for varying the directivity are sound signals to change at least one of directivity sharpness or a directional main axis.

12. The signal processing apparatus according to claim 1, wherein
the plurality of microphones has characteristics which are same as one another.

13. The signal processing apparatus according to claim 1, wherein
the directivity processing unit generates, as the sound signals for varying the directivity, sound signals of two channels or sound signals of four channels.

14. The signal processing apparatus according to claim 1, further comprising
the plurality of microphones.

15. A signal processing apparatus comprising:
an input unit to which sound signals for varying directivity are inputted, the sound signals being generated by using sound signals of a plurality of channels, the sound signals of the plurality of channels being concurrently picked up by a microphone array being constituted of a plurality of microphones, a number of the sound signals for varying the directivity being smaller than a number of the channels, directional characteristics of the sound signals for varying the directivity being different from each other; and
a directivity variable unit which synthesizes the sound signals for varying the directivity being inputted to the input unit at a predetermined ratio and generates a sound signal having directivity in accordance with the ratio.

16. A signal processing method, wherein
a directivity processing unit acquires sound signals of a plurality of channels, the sound signals of the plurality of channels being concurrently picked up by a microphone array being constituted of a plurality of microphones, and generates sound signals for varying directivity by using the acquired sound signals of the plurality of channels, a number of the sound signals for varying the directivity being smaller than a number of the channels, directional characteristics of the sound signals for varying the directivity being different from each other.

17. A program which causes a computer to execute a signal processing method, wherein
a directivity processing unit acquires sound signals of a plurality of channels, the sound signals of the plurality of channels being concurrently picked up by a microphone array being constituted of a plurality of microphones, and generates sound signals for varying directivity by using the acquired sound signals of the plurality of channels, a number of the sound signals for varying the directivity being smaller than a number of the channels, directional characteristics of the sound signals for varying the directivity being different from each other.

18. A directivity variable system comprising:
a directivity processing unit which acquires sound signals of a plurality of channels, the sound signals being concurrently picked up by a microphone array being constituted of a plurality of microphones, the directivity processing unit generating sound signals for varying directivity by using the acquired sound signals of the plurality of channels, a number of the sound signals for varying the directivity being smaller than a number of the channels, directional characteristics of the sound signals for varying the directivity being different from each other;
a recording unit which records, in a recording medium, the sound signals for varying the directivity being generated by the directivity processing unit;
a directivity variable unit which acquires the sound signals for varying the directivity being read out from the recording medium, synthesizes the acquired sound signals for varying the directivity at a predetermined ratio, and generates a sound signal having directivity in accordance with the ratio; and
a reproducing unit which reproduces the sound signal being generated by the directivity variable unit.
